(19) United States
(12) Patent Application Publication
(10) Pub. No.: US 2026/0238482 A1
(43) Pub. Date: Aug. 13, 2026

(54) METHODS, APPARATUS AND COMPUTER-READABLE MEDIA FOR ENABLING AN APPLICATION FUNCTION TO UTILIZE RESOURCES OF A RESOURCE OWNER

(71) Applicant: TELEFONAKTIEBOLAGET LM ERICSSON (PUBL), STOCKHOLM (SE)

(72) Inventors: Helena Flygare, Lund (SE); Ferhat Karakoc, Istanbul (TR)

(21) Appl. No.: 19/156,075

(22) PCT Filed: Feb. 13, 2024
(86) PCT No.: PCT/IB2024/051350

§ 371 Date: Aug. 13, 2025

Related U.S. Application Data
(60) Provisional application No. 63/445,200, filed on Feb. 13, 2023.

(51) Int. Cl. H04L 9/32; H04L 9/40

(52) U.S. Cl. CPC H04L 9/3213; H04L 9/40

(57) ABSTRACT

Methods and apparatuses for enabling an AF to utilize resources of a resource owner are provided. A method performed by an authorization server (610) to enable an AF to utilize resources of a resource owner comprises providing, to the AF, authorization to utilize the resources of the resource owner. The resources of the resource owner are stored in an operator network.

### TECHNICAL FIELD

Embodiments of the present disclosure relate to methods, user equipments (UEs), authorization servers, Application Function (AF) network nodes and resource servers, and particularly methods, user equipments (UEs), authorization servers, AF network nodes and resource servers for enabling AFs to utilize resources of resource owners.

### BACKGROUND

The user consent framework as described in Annex V of TS 33.501 Security architecture and procedures for 5G System, available at https://www.3gpp.org/ftp/Specs/archive/33_series/33.501/33501-i00.zip as of 31 Jan. 2024, provides a mechanism for consent to be given to an operator to allow it to use specific data for a specific purpose. However, for use cases for specific features such as Edge Computing (EC), Artificial Intelligence/Machine Learning (AI/ML), enhanced Network Automation (eNA), and Subscriber-aware North-Bound (NB) Application Programming Interface (API) Access Security (SNAAPPY), sharing data to an external Application Function (AF) might also be needed. For example, this information may be needed to enable the AF to provide a service to a user/subscriber that has a service relation to the AF. There is currently no mechanism specified for user consent such that the user/subscriber may authorize an external party (e.g., a 3PP) to access their data (e.g., personally identifiable information (PII) and/or other types of data in an operator network).

In SNAAPPY study TR 33.884 v0.4.0: Study on application enablement aspects for subscriber-aware northbound API access, available at https://portal.3gpp.org/desktopmodules/Specifications/SpecificationDetails.aspx?specificationId=4077 as of 31 Jan. 2024, there are some solutions (e.g., solution #1, solution #7, solution #9, solution #11) that propose the use of Open Authorization (OAuth) 2.0 framework (see IETF RFC 6749: The OAuth 2.0 Authorization Framework, available at https://datatracker.ietf.org/doc/html/rfc6749 as of 31 Jan. 2024) or PKCE flow (see IETF RFC 7636: Proof Key for Code Exchange by OAuth Public Clients, available at https://datatracker.ietf.org/doc/html/rfc7636 as of 31 Jan. 2024) to allow the user/subscriber to authorize an external party to access user related data.

There currently exist certain challenge(s). The current user consent mechanisms specified by Annex V of TS 33.501 do not allow for a user/subscriber to authorize an operator to share data (e.g., PII) to an external AF. Therefore, these consent mechanisms often do not fulfill regulatory requirements for consent, e.g. the General Data Protection Regulation (GDPR). For GDPR, it should be certain that:
1. Authorization (also referred to in this disclosure as consent or permission) has a well-defined scope of: data, purpose, who it is given to etc.;
2. The authorization is given freely by an individual whose data is to be processed (as opposed to given by someone on behalf of this person or given under pressure);
3. The permission given is revocable at any time by the individual; and
4. Consent is not given once and considered generally applicable, and it is not given to party A and then used by party B, unless party A, in asking for consent already pre-emptively stated that party B would gain access to that data too.

If the conditions 1-4 above cannot be fulfilled, the consent would likely not be considered legally valid with regards to GDPR.

Similarly, the Annex V has the following issues:
User Consent/Authorization is given to an operator to process data for a purpose. There are no mechanisms to give consent/authorization to an operator to share that data with an AF. To be considered legally valid with regards to regulatory requirements for consent, consent needs to be specific with respect to data, purpose and whom it is given to.

The solutions in SNAAPPY TR 33.884 focus on the Common API framework (CAPIF) specified in TS 23.222, TS 33.122 and TS 29.222 (all available via the 3GPP website https://portal.3gpp.org/#/ as of 31 Jan. 2024), but CAPIF is not necessarily supported for north-bound APIs. For example, 3rd Generation Partnership Project (3GPP) systems can expose data via NB APIs without using a CAPIFs.

### SUMMARY

Certain aspects of the disclosure and their embodiments may provide solutions to the challenges above or other challenges.

An embodiment of the disclosure provides a method performed by a UE to enable an AF to utilize resources of a resource owner. The method comprises providing, to the AF, authorization to utilize the resources of the resource owner, wherein the resources of the resource owner are stored in an operator network.

A further embodiment of the disclosure provides a method performed by an authorization server to enable an AF to utilize resources of a resource owner. The method comprises providing, to the AF, authorization to utilize the resources of the resource owner, wherein the resources of the resource owner are stored in an operator network.

A further embodiment of the disclosure provides a method performed by an AF to enable the AF to utilize resources of a resource owner. The method comprises obtaining, from an authorization server, authorization to utilize the resources of the resource owner, wherein the resources of the resource owner are stored in an operator network.

A further embodiment of the disclosure provides a method performed by a resource server in an operator network to enable an AF to utilize resources of a resource owner. The method comprises receiving, from the AF, a request to access the resources of the resource owner. The method further comprises providing, to the AF, access to the resources of the resource owner, wherein the resources of the resource owner are stored in the resource server.

Further embodiments of the disclosure provide UEs, authorization servers, network nodes hosting AFs, and resource servers, configured to perform the methods as discussed herein.

Embodiments of the present disclosure make it possible for a user/subscriber to authorize an AF to access specific data for a specific purpose (which the AF can use to provide a user/subscriber with a particular service). In some embodiments, the permission given can be revoked at any time by the user/subscriber. In addition, embodiments of the present disclosure allow for consent to be preemptively given to an AF to enable the AF to gain access to data in the operator network. Some existing solutions approach consent problems from an “authorization by the user/subscriber” perspective; embodiments of the present disclosure may relate to user consent and may support specific conditions as explained above.

Whilst OAuth-based authorization mechanism may already be used in 3GPP, there are different ways of using the mechanism of the RFC 6749 [3] and they give different properties.

For example, embodiments of the present disclosure enable the use of Oauth to make it possible for a user to authorize (consent) that their data can be shared by an operator to an external AF (e.g., when the user has a relation to the AF). Embodiments of the present disclosure enable a user to consent/authorize to the sharing of their data per application. Embodiments of the present disclosure introduce a new entity called a “resource server” which can manages a user's data in an operator network (e.g., a 3GPP system). In some embodiments, the user's data may be or comprise Personal Identifiable Information (PII). In some embodiments, the user's data may originate, for example: from PII data stored on a UE; from measurements or other data from the UE sent to a network; from measurements/computations/algorithms from Radio or Core networks for a specific UE; from PII data sent to network(s) (RAN and/or Core) and further processed with algorithms while preserving the PII.

It is an object of embodiments of the present disclosure to enable a user to consent to/authorize an operator to share specific data per application to specific AFs.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows a method performed by a wireless device according to embodiments of the disclosure;

FIG. 2 shows a method performed by a network node according to embodiments of the disclosure;

FIG. 3 shows a method performed by a network node according to embodiments of the disclosure;

FIG. 4 shows a method performed by a network node according to embodiments of the disclosure;

FIG. 5 illustrates network architecture according to embodiments of the disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host in accordance with various aspects described herein;

FIG. 10 is a block diagram illustrating a virtualization environment in which functions implemented by some embodiments may be virtualized;

FIG. 11 shows a communication diagram of a host communicating via a network node with a UE over a partially wireless connection in accordance with some embodiments; and

FIG. 12 shows a network node in accordance with further embodiments.

### ADDITIONAL EXPLANATION

Some of the embodiments contemplated herein will now be described more fully with reference to the accompanying drawings. Embodiments are provided by way of example to convey the scope of the subject matter to those skilled in the art.

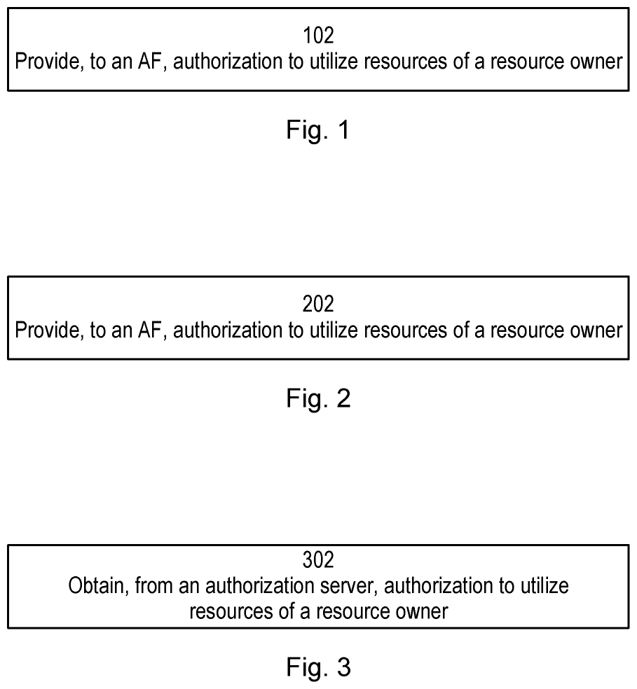

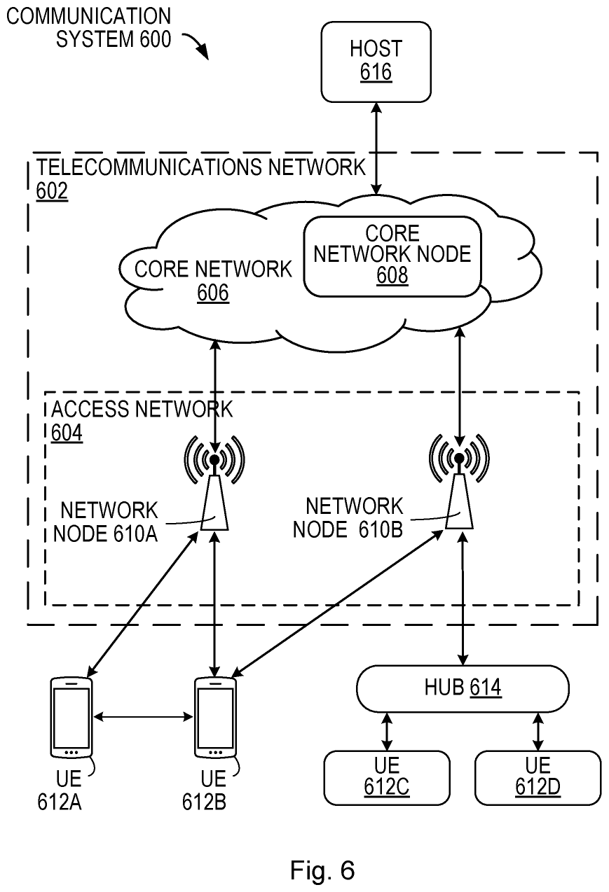

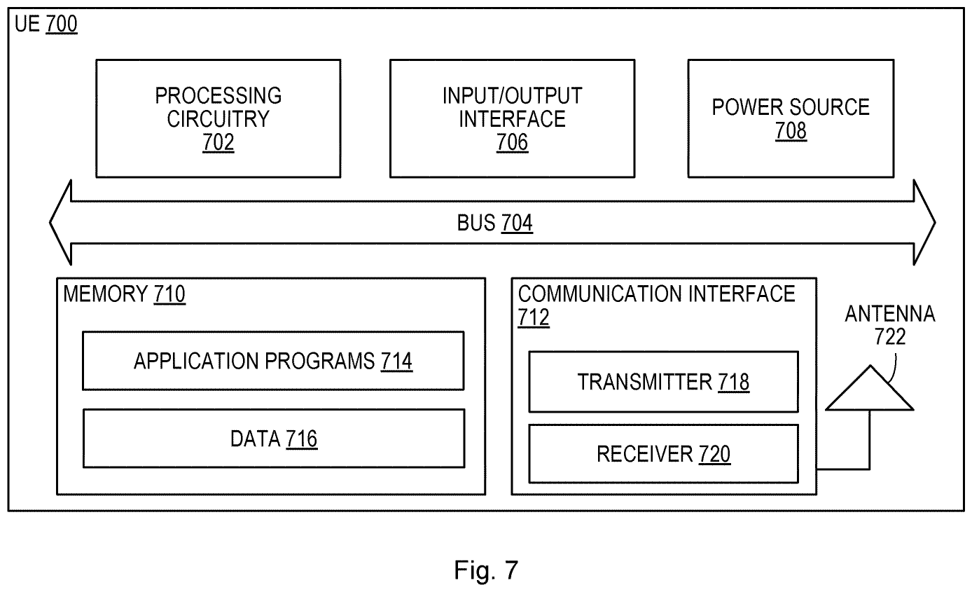

FIG. 1 depicts a method in accordance with particular embodiments. The method 1 may be performed by a UE or wireless device (e.g. the UE 612 or UE 700 as described later with reference to FIGS. 6 and 7 respectively). The method may enable an AF to utilize resources of a resource owner. The method begins at step 102 with providing, to the AF, authorization to utilize the resources of the resource owner.

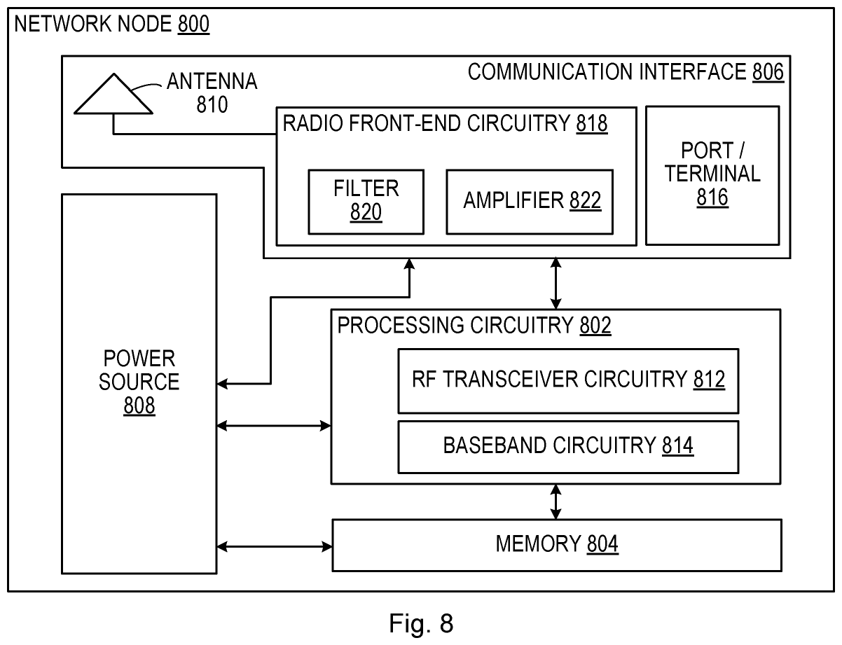

FIG. 2 depicts a method in accordance with particular embodiments. The method 2 may be performed by a network node (e.g. the network node 610 or network node 800 as described later with reference to FIGS. 6 and 8 respectively). In some embodiments, the network node may be an authorization server. The method may enable an AF to utilize resources of a resource owner. The method begins at step 202 with providing, to the AF, authorization to utilize the resources of the resource owner.

FIG. 3 depicts a method in accordance with particular embodiments. The method 3 may be performed by a network node (e.g. the network node 610 or network node 800 as described later with reference to FIGS. 6 and 8 respectively). In some embodiments, the network node may be an AF. The method may enable an AF to utilize resources of a resource owner. The method begins at step 302 with obtaining, from an authorization server, authorization to utilize the resources of the resource owner.

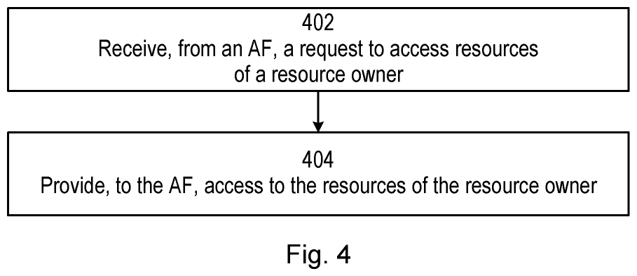

FIG. 4 depicts a method in accordance with particular embodiments. The method 4 may be performed by a network node (e.g. the network node 610 or network node 800 as described later with reference to FIGS. 6 and 8 respectively). In some embodiments, the network node may be a resource server. The method may enable an AF to utilize resources of a resource owner. The method begins at step 402 with receiving, from the AF, a request to access the resources of the resource owner. At step 404, the network node provides, to the AF, access to the resources of the resource owner.

A user/subscriber may use an application/service on a UE (e.g., an application/service provided by an AF). In order for the application/service to function optimally, the user/subscriber may need to allow the exchange of data (e.g., from an operator network) with a “client” in the AF. For example, there may be data related to a user in the 3GPP system that the client in the AF needs in order to optimally provide a service to the user. In other words, the AF may utilize the resources of the resource owner to provide a service to a UE operated by the resource owner. For example, the resources of the resource owner may be stored in a resource server in an operator network and the AF may be external to the operator network. In some embodiments, a UE may provide, to a resource server in an operator network (e.g., a 3GPP network), the resources of the resource owner. In some embodiments the client may itself be the AF.

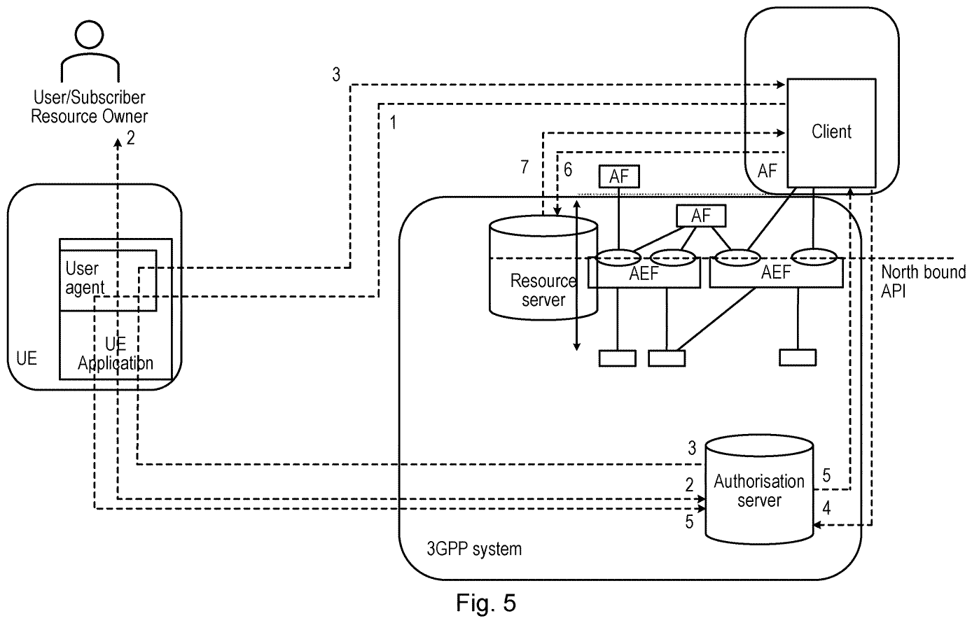

FIG. 5 illustrates network architecture according to embodiments of the disclosure.

The “resource server” in FIG. 5 manages a user's data in a network (e.g., a 3GPP system). In some embodiments, the resource server is co-located with a Northbound API (e.g., a Northbound API in a 3GPP system).

The “Client” in FIG. 5 may wish to use the user's data. The client may be a client application hosted by an AF, or it may be the AF. The northbound API can pass the user's data through. The AF may be external to the operator network, or within the operator network.

An authorization code grant type is used in FIG. 5 to obtain both access tokens and refresh tokens and can be optimized for confidential clients. In some embodiments, a redirection-based flow is used, in which case the client should be capable of: interacting with a resource owner's user agent; and be capable of receiving incoming requests (via redirection) from an authorization server.

In embodiments of the present disclosure, one or more of the following steps may be performed (e.g., steps of an OAuth 2.0 process). These steps are illustrated in FIG. 5 by the dashed lines. Note that the lines illustrating steps (1), (2), and (3) may be broken into two parts as they pass through the user-agent. The steps are:

1. Authorization Request/Client Identifier & Redirection URI: The client may request authorization from the resource owner. The authorization request may be made indirectly via an authorization server as an intermediary. In other words, the authorization server may receive, from the AF, a request for authorization to utilize the resources of the resource owner, and the authorization server may forward the request to the UE. Therefore, in some embodiments, the UE may obtain, from the AF, a request for authorization to utilize the resources of the resource owner. The client may initiate the flow by directing the resource owner's user-agent to the authorization endpoint. In some embodiments, the request for authorization may comprise any one or more of: an identifier; a scope of use of the resources of the resource owner; a local state; and a redirection Uniform Resource Identifier (URI). In examples where the client is an application hosted by the AF, the client may include a client identifier, a requested scope, a local state of the client, and a redirection URI to which the authorization server will send the user-agent back once access is granted (or denied). In examples where the client is an AF, the client may include an AF identifier, a requested scope, a local state of the AF, and a redirection URI to which the authorization server will send the user-agent back once access is granted (or denied). Alternatively, in other embodiments, the authorization server may obtain the authorization upon connection of the UE to the operator network.

2. User authenticates: The authorization server may authenticate the resource owner (via the user-agent) and establish whether the resource owner grants or denies the client's access request. In other words, in some embodiments, the authorization server may provide the authorization to the AF via a UE operated by the resource owner. In other embodiments, a UE operated by the resource owner may provide the authorization to the AF via the authorisation server.

3. Authorization Grant/Authorization Code: The UE and/or the authorization server may determine whether the resource owner grants authorization to the AF to utilize the resources of the resource owner. For example, this may involve the authorization server receiving, from a UE operated by the resource owner, an indication that the resource owner grants authorization to the AF to utilize the resources of the resource owner. Assuming the resource owner grants access, the authorization server redirects the user-agent back to the client using the redirection URI provided earlier (in the request or during client registration). The redirection URI includes a authorization code and any local state provided by the client earlier. In other words, the authorization server may provide, to the AF, authorization to utilize the resources of the resource owner. In some embodiments, the resources of the resource owner may be stored in an operator network and the AF may be external to the operator network. For example, the authorization server may provide an authorization code to the AF.

4. Authorization Code & Redirection URI: The client requests an access token from the authorization server's token endpoint by including the authorization code received in the previous step. In other words, the authorization server may receive, from the AF, a request for an access token, the request for the access token comprising the authorization code. When making the request, the client authenticates with the authorization server. For example, in response to receiving a request for an access token, the authorization server may determine the validity of the request for the access token. The client may include the redirection URI used to obtain the authorization code for verification.

5. Access Token: The authorization server authenticates the client, validates the authorization code, and ensures that the redirection URI received matches the URI used to redirect the client in step (3). If valid, the authorization server responds back with an access token. In other words, when a request for an access token is determined to be valid, the authorization server may provide, to the AF, the access token.

6. Access Token: The client makes a protected resource request to the resource server by presenting the access token. In other words, the resource server may receive, from the AF, a request to access the resources of the resource owner. For example, the request to access the resources of the resource owner may comprise an access token.

7. Protected Resource: The resource server validates the access token, and if valid, serves the request. That is, if valid, the resource server provides, to the AF, access to the resources of the resource owner.

In some embodiments, the authorization server may receive, from a UE operated by the resource owner, an indication that the authorization to utilize the resources of the resource owner is revoked. The authorization server may provide, to the AF, an indication that the authorization to utilize the resources of the resource owner is revoked.

In some embodiments, steps 6 and 7 may be executed via a corresponding API Exposing Function (AEF). Where a corresponding AEF is used, the steps may be executed as follows:
The client sends the access token to the AEF,
the AEF forwards the access token received from the client to the resource server,
the resource server validates the access token and if it is valid then sends the related data to the AEF,
the AEF forwards the data to the client.

In an alternative embodiment, the AEF may itself be regarded as the resource server.

The PKCE flow [4] which is security enhanced version of the authorization code flow of OAuth 2.0 can also be used as another flow.

Below are some example entities for the roles defined above (e.g., roles used in OAuth 2.0). Embodiments may utilise the entities listed below, or other entities.
Resource owner: may be any entity capable of granting access to a protected resource. When the resource owner is a person, it may be referred to as an end-user. This can be the end user of UE or the subscription owner.
Resource server: may be the server hosting the protected resources. It may be capable of accepting and responding to protected resource requests using access tokens. This can be the AEF or the resource server as shown in FIG. 5. Note that, in some embodiments, the AEF can be: an Network Exposure Function (NEF) as shown in FIG. 5; an Edge Enabler Server (in an edge computing context); or any function/server that exposes data via API.
Client: may be any application making protected resource requests on behalf of the resource owner and with its authorization. The term “client” may not imply any particular implementation characteristics (e.g., whether the application executes on a server, a desktop, or other devices). The client may be a client application hosted on an application function, or it can be the application function.
Authorization server: may be the server issuing access tokens to the client after successfully authenticating the resource owner and obtaining authorization. The authorization server may be the same server as the resource server or a separate entity.

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 6, the hub 614 communicates with the access network 604 to facilitate indirect communication between one or more UEs (e.g., UE 612c and/or 612d) and network nodes (e.g., network node 610b). In some examples, the hub 614 may be a controller, router, a content source and analytics node, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub-that is, a hub whose primary function is to route communications to/from the UEs from/to the network node 610b. In other embodiments, the hub 614 may be a non-dedicated hub-that is, a device which is capable of operating to route communications between the UEs and network node 610b, but which is additionally capable of operating as a communication start and/or end point for certain data channels.

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs). The processing circuitry 702 may be operable to provide, either alone or in conjunction with other UE 700 components, such as the memory 710, UE 700 functionality. For example, the processing circuitry 702 may be configured to cause the UE 702 to perform the methods as described with reference to FIG. 1.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In some embodiments, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, a memory 804, a communication interface 806, and a power source 808, and/or any other component, or any combination thereof. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, network node 800 functionality. For example, the processing circuitry 802 may be configured to cause the network node to perform the methods as described with reference to FIGS. 2, 3, and 4.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

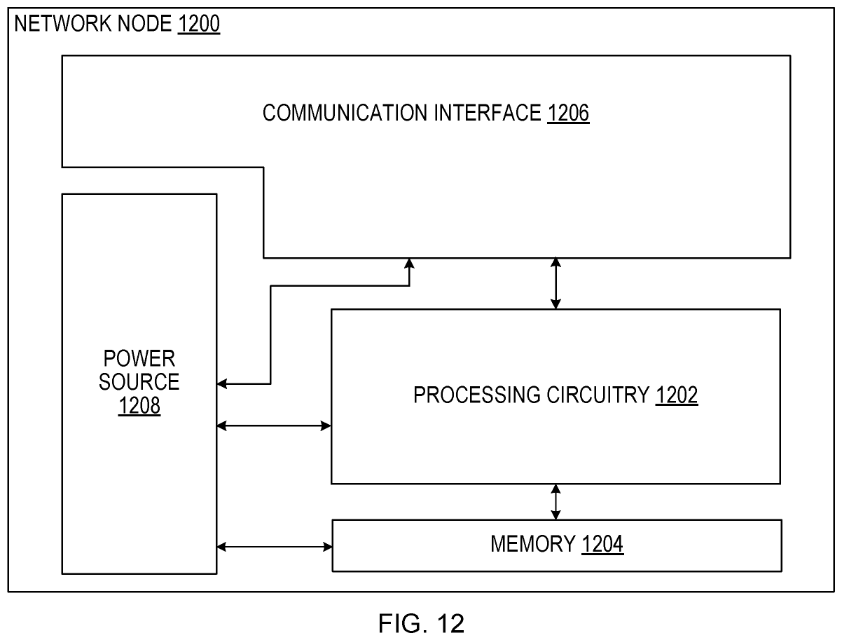

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. The network node 1200 may be operable as a core network node, a core network function or, more generally, a core network entity, such as the core network node 608 described above with respect to FIG. 6). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node 1200 includes processing circuitry 1202, a memory 1204, a communication interface 1206, and a power source 1208, and/or any other component, or any combination thereof. The network node 1200 may be composed of multiple physically separate components, which may each have their own respective components. In certain scenarios in which the network node 1200 comprises multiple separate components, one or more of the separate components may be shared among several network nodes.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, network node 1200 functionality.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

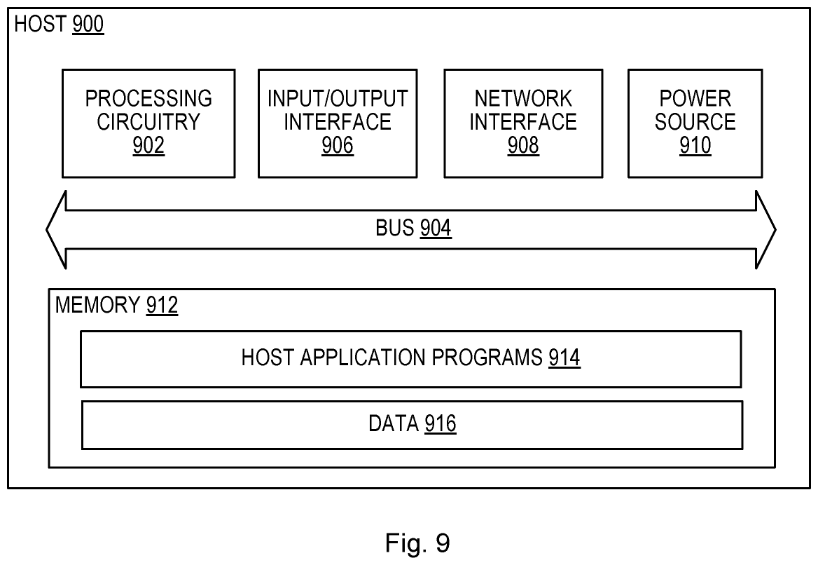

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

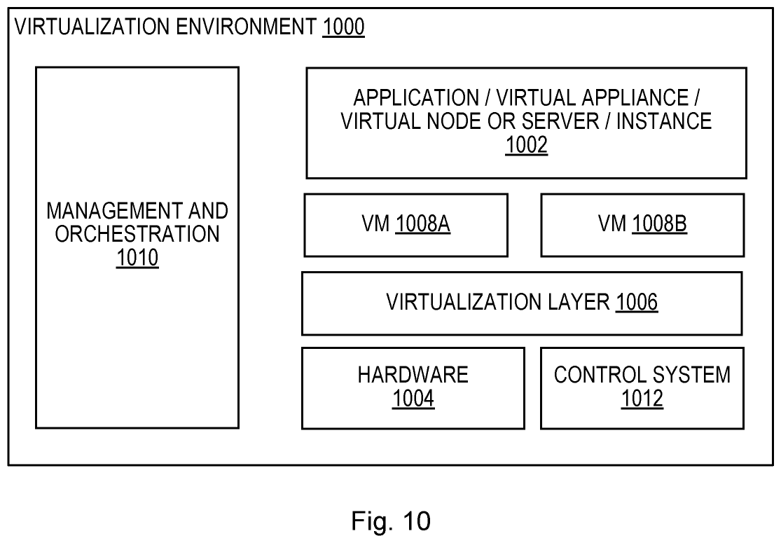

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

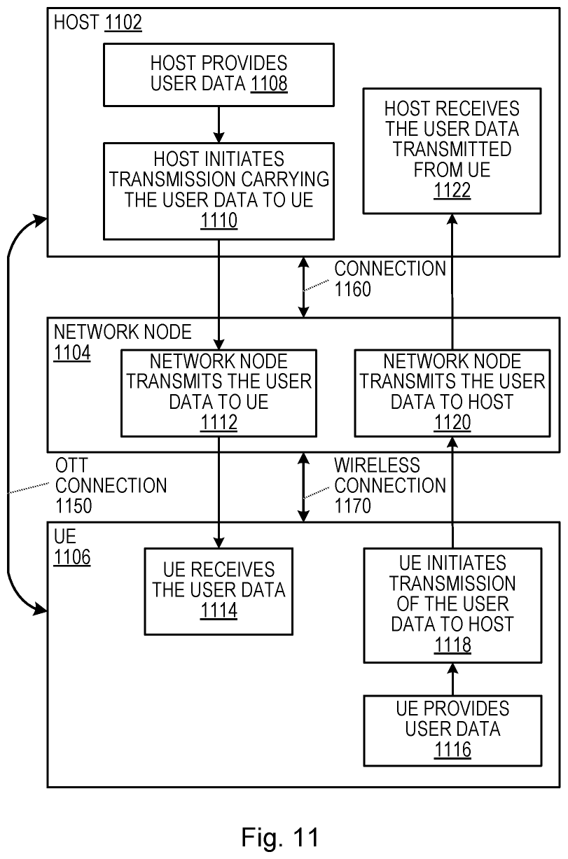

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the performance of a service provided by an application function (e.g., by improving an associated data rate, latency, and/or power consumption) and thereby provide benefits such as a reduced user waiting time, relaxed restrictions on file size, improved content resolution, better responsiveness, and/or extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc. ; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following numbered embodiments provide additional information on the disclosure:

1. A method performed by a user equipment, UE, to enable an application function, AF, to utilize resources of a resource owner, the method comprising:
Providing to the AF, authorization to utilize the resources of the resource owner, wherein the resources of the resource owner are stored in an operator network.

2. The method according to embodiment 1, wherein the AF is external to the operator network.

3. The method according to embodiments 1 or 2, further comprising:
obtaining, from the AF, a request for authorization to utilize the resources of the resource owner.

4. The method according to embodiment 3, wherein the request for authorization comprises any one or more of: an identifier; a scope of use of the resources of the resource owner; a local state; and a redirection Uniform Resource Identifier, URI.

5. The method according to embodiments 1 or 2, wherein the UE provides authorization to the AF upon connection to the operator network.

6. The method according to any one of the preceding embodiments, wherein the authorization is provided to the client via an authorization server.

7. The method according to any one of the preceding embodiments, the method comprising:
determining whether the resource owner grants authorization for the AF to utilize the resources of the resource owner.

8. The method according to any one of the preceding embodiments, further comprising:
providing, to an authorization server or the client, an indication that the authorization to utilize the resources of the resource owner is revoked.

9. The method according to any one of the preceding embodiments, further comprising:
providing, to a resource server in the operator network, the resources of the resource owner.

10. The method according to any one of the preceding embodiments, further comprising:
providing user data; and
forwarding the user data to a host via the transmission to the network node.

11. A method performed by an authorization server to enable an application function, AF, to utilize resources of a resource owner, the method comprising:
providing, to the AF, authorization to utilize the resources of the resource owner, wherein the resources of the resource owner are stored in an operator network.

12. The method according to embodiment 11, wherein the AF is external to the operator network.

13. The method according to embodiment 11 or 12, wherein the authorization server provides the authorization to the AF via a user equipment, UE, operated by the resource owner.

14. The method according to any one of embodiments 11 to 13, wherein providing the authorization to the AF comprises:
providing an authorization code to the AF.

15. The method according to embodiment 14, the method further comprising:
receiving, at the authorization server from the AF, a request for an access token, the request for the access token comprising the authorization code.

16. The method according to embodiment 15, the method further comprising:
in response to receiving the request for the access token, determining the validity of the request for the access token; and
when the request for the access token is determined to be valid, providing, to the AF, the access token.

17. The method according to any one of embodiments 11 to 16, further comprising:
determining whether the resource owner grants authorization to the AF to utilize the resources of the resource owner.

18. The method according to embodiment 17, wherein determining whether the resource owner grants authorization to the AF comprises:
receiving, from a UE operated by the resource owner, an indication that the resource owner grants authorization to the AF to utilize the resources of the resource owner.

19. The method according to embodiment 18, the method further comprising:
receiving, from the AF, a request for authorization to utilize the resources of the resource owner; and wherein the indication that the resource owner grants authorization to the AF is received responsive to the authorization server forwarding the request to the UE.

20. The method according to embodiment 19, wherein the request for authorization comprises any one or more of: an identifier; a scope of use of the resources of the resource owner; a local state; and a redirection Uniform Resource Identifier, URI.

21. The method according to embodiment 18, wherein the authorization server obtains the authorization upon connection of the UE to the operator network.

22. The method according to any one of embodiments 11 to 21, the method further comprising:
receiving, from a UE operated by the resource owner, an indication that the authorization to utilize the resources of the resource owner is revoked.

23. The method according to any one of embodiments 11 to 22, the method further comprising:
providing, to the AF, an indication that the authorization to utilize the resources of the resource owner is revoked.

24. The method according to any one of embodiments 11 to 23, wherein the AF utilizes the resources of the resource owner to provide a service to a UE operated by the resource owner.

25. The method according to any one of embodiments 11 to 24, wherein the AF hosts a client application, or wherein the AF is a client application.

26. A method performed by an application function, AF, to enable the AF to utilize resources of a resource owner, the method comprising:
obtaining, from an authorization server, authorization to utilize the resources of the resource owner, wherein the resources of the resource owner are stored in an operator network.

27. The method according to embodiment 26, wherein the AF is external to the operator network.

28. The method according to embodiment 26 or 27, wherein the AF obtains the authorization from the authorization server via a User Equipment, UE, operated by the resource owner.

29. The method according to any one of embodiments 26 to 28, wherein obtaining the authorization from the authorization server comprises:
obtaining an authorization code provided by the authorization server.

30. The method according to embodiment 29, the method further comprising:
transmitting, to the authorization server, a request for an access token, the request for the access token comprising the authorization code.

31. The method according to embodiment 30, the method further comprising:
receiving, from the authorization server, an access token.

32. The method according to embodiment 31, the method further comprising:
transmitting, to a resource server in the operator network, a request to access the resources of the resource owner, wherein the request comprises the access token.

33. The method according to embodiment 32, the method further comprising:
receiving, from the resource server, access to the resources of the resource owner.

34. The method according to any one of embodiments 26 to 33, the method further comprising:
transmitting, to the authorization server or a UE operated by the resource owner, a request for authorization to utilize the resources of the resource owner.

35. The method according to embodiment 34, wherein the request for authorization comprises any one or more of: an identifier; a scope of use of the resources of the resource owner; a local state; and a redirection Uniform Resource Identifier, URI.

36. The method according to embodiment 26 to 33, wherein the AF obtains the authorization upon connection of a UE operated by the resource owner to the operator network.

37. The method according to any one of embodiments 26 to 36, the method further comprising:
receiving, from the authorization server or a UE operated by the resource owner, an indication that the authorization to utilize the resources of the resource owner is revoked.

38. The method according to any one of embodiments 26 to 37, wherein the AF utilizes the resources of the resource owner to provide a service to a UE operated by the resource owner.

39. The method according to any one of embodiments 26 to 38, wherein the AF hosts a client application, or wherein the AF is a client application.

40. A method performed by a resource server in an operator network to enable an application function, AF, to utilize resources of a resource owner, the method comprising:
receiving, from the AF, a request to access the resources of the resource owner; and
providing, to the AF, access to the resources of the resource owner, wherein the resources of the resource owner are stored in the resource server.

41. The method according to embodiment 40, wherein the AF is external to the operator network.

42. The method according to embodiment 40 or 41, the method further comprising:
validating the request to access the resources of the resource owner.

43. The method according to any one of embodiments 40 to 42, wherein the request to access the resources of the resource owner comprises an access token.

44. The method according to any one of embodiments 40 to 43, the method further comprising:
obtaining, from a User Equipment, UE, operated by the resource owner, the resources of the resource owner.

45. The method according to any one of embodiments 40 to 44, wherein the AF hosts a client application, or wherein the AF is a client application.

46. A user equipment for enabling an application function, AF, to utilize resources of a resource owner, the user equipment comprising:
processing circuitry configured to cause the user equipment to perform any of the steps of any of embodiments 1 to 10; and
power supply circuitry configured to supply power to the processing circuitry.

47. A network node for enabling an application function, AF, to utilize resources of a resource owner, the network node comprising:
processing circuitry configured to cause the network node to perform any of the steps of any of embodiments 11 to 45;
power supply circuitry configured to supply power to the processing circuitry.

48. A user equipment (UE) for enabling an application function, AF, to utilize resources of a resource owner, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of embodiments 1 to 10;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

49. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of embodiments 1 to 10 to receive the user data from the host.

50. The host of embodiment 49, wherein the cellular network further includes a network node configured to communicate with the UE to transmit the user data to the UE from the host.

51. The host of embodiments 49 and 50, wherein:
the processing circuitry of the host is configured to execute a host application, thereby providing the user data; and
the host application is configured to interact with a client application executing on the UE, the client application being associated with the host application.

52. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of embodiments 1 to 10 to receive the user data from the host.

53. The method of embodiment 52, further comprising:
at the host, executing a host application associated with a client application executing on the UE to receive the user data from the UE.

54. The method of embodiment 53, further comprising:
at the host, transmitting input data to the client application executing on the UE, the input data being provided by executing the host application,
wherein the user data is provided by the client application in response to the input data from the host application.

55. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of embodiments 1 to 10 to transmit the user data to the host.

56. The host of embodiment 55, wherein the cellular network further includes a network node configured to communicate with the UE to transmit the user data from the UE to the host.

57. The host of embodiments 55 and 56, wherein:
the processing circuitry of the host is configured to execute a host application, thereby providing the user data; and
the host application is configured to interact with a client application executing on the UE, the client application being associated with the host application.

58. A method implemented by a host configured to operate in a communication system that further includes a network node and a user equipment (UE), the method comprising:
at the host, receiving user data transmitted to the host via the network node by the UE, wherein the UE performs any of the steps of any of embodiments 1 to 10 to transmit the user data to the host.

59. The method of embodiment 58, further comprising:
at the host, executing a host application associated with a client application executing on the UE to receive the user data from the UE.

60. The method of embodiment 59, further comprising:
at the host, transmitting input data to the client application executing on the UE, the input data being provided by executing the host application,
wherein the user data is provided by the client application in response to the input data from the host application.

61. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of embodiments 11 to 45 to transmit the user data from the host to the UE.

62. The host of embodiment 61, wherein:
the processing circuitry of the host is configured to execute a host application that provides the user data; and
the UE comprises processing circuitry configured to execute a client application associated with the host application to receive the transmission of user data from the host.

63. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of embodiments 11 to 45 to transmit the user data from the host to the UE.

64. The method of embodiment 63, further comprising, at the network node, transmitting the user data provided by the host for the UE.

65. The method of any of embodiments 63 and 64, wherein the user data is provided at the host by executing a host application that interacts with a client application executing on the UE, the client application being associated with the host application.

66. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of embodiments 11 to 45 to transmit the user data from the host to the UE.

67. The communication system of embodiment 66, further comprising:
the network node; and/or
the user equipment.

68. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of embodiments 11 to 45 to receive the user data from a user equipment (UE) for the host.

69. The host of embodiment 68, wherein:
the processing circuitry of the host is configured to execute a host application, thereby providing the user data; and
the host application is configured to interact with a client application executing on the UE, the client application being associated with the host application.

70. The host of the any of embodiments 68 and 69, wherein the initiating receipt of the user data comprises requesting the user data.

71. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of embodiments 11 to 45 to receive the user data from the UE for the host.

72. The method of embodiment 71, further comprising at the network node, transmitting the received user data to the host.

1. A method performed by a user equipment, UE, to enable an application function, AF, to utilize resources of a resource owner, the method comprising:
providing to the AF, authorization to utilize the resources of the resource owner, wherein the resources of the resource owner are stored in an operator network.

2. The method according to claim 1, wherein the AF is external to the operator network.

3. The method according to claim 1, further comprising:
obtaining, from the AF, a request for authorization to utilize the resources of the resource, optionally wherein the request for authorization comprises any one or more of: an identifier; a scope of use of the resources of the resource owner; a local state;
and a redirection Uniform Resource Identifier, URI.

4. The method according to claim 1, wherein the UE provides authorization to the AF upon connection to the operator network.

5-8. (canceled)

9. A method performed by an authorization server to enable an application function, AF, to utilize resources of a resource owner, the method comprising:
providing, to the AF, authorization to utilize the resources of the resource owner, wherein the resources of the resource owner are stored in an operator network.

10. The method according to claim 9, wherein the AF is external to the operator network.

11. The method according to claim 9, wherein the authorization server provides the authorization to the AF via a user equipment, UE, operated by the resource owner.

12. The method according to claim 9, wherein providing the authorization to the AF comprises:
providing an authorization code to the AF, optionally wherein the method further comprises:
receiving, at the authorization server from the AF, a request for an access token, the request for the access token comprising the authorization code.

13. The method according to claim 12, the method further comprising:
in response to receiving the request for the access token, determining the validity of the request for the access token; and
when the request for the access token is determined to be valid, providing, to the AF, the access token.

14. The method according to claim 9, further comprising:
determining whether the resource owner grants authorization to the AF to utilize the resources of the resource owner.

15. The method according to claim 14, wherein determining whether the resource owner grants authorization to the AF comprises:
receiving, from a UE operated by the resource owner, an indication that the resource owner grants authorization to the AF to utilize the resources of the resource owner.

16. The method according to claim 15, the method further comprising:
receiving, from the AF, a request for authorization to utilize the resources of the resource owner; and wherein the indication that the resource owner grants authorization to the AF is received responsive to the authorization server forwarding the request to the UE.

17. The method according to claim 16, wherein the request for authorization comprises any one or more of: an identifier; a scope of use of the resources of the resource owner; a local state; and a redirection Uniform Resource Identifier, URI, optionally wherein the authorization server obtains the authorization upon connection of the UE to the operator network.

18. The method according to claim 9, the method further comprising:
receiving, from a UE operated by the resource owner, an indication that the authorization to utilize the resources of the resource owner is revoked.

19. The method according to claim 9, the method further comprising:
providing, to the AF, an indication that the authorization to utilize the resources of the resource owner is revoked.

20. The method according to claim 9, wherein the AF utilizes the resources of the resource owner to provide a service to a UE operated by the resource owner, and/or wherein the AF hosts a client application, or wherein the AF is a client application.

21. A method performed by an application function, AF, to enable the AF to utilize resources of a resource owner, the method comprising:
obtaining, from an authorization server authorization to utilize the resources of the resource owner, wherein the resources of the resource owner are stored in an operator network.

22. The method according to claim 21 wherein the AF is external to the operator network.

23. The method according to claim 21, wherein the AF obtains the authorization from the authorization server via a User Equipment, UE operated by the resource owner.

24. (canceled)

25. The method according to claim 21, the method further comprising:
transmitting, to the authorization server a request for an access token, the request for the access token comprising the authorization code.

26-41. (canceled)
